(19) United States
(12) Patent Application Publication
(10) Pub. No.: US 2020/0404533 A1
(43) Pub. Date: Dec. 24, 2020

(54) WIRELESS DEVICE AND METHOD THEREIN FOR ENABLING REFLECTIVE QUALITY OF SERVICE (QOS)

(71) Applicant: Telefonaktiebolaget LM Ericsson (publ), Stockholm (SE)

(72) Inventors: Daniel Nilsson, Älvängen (SE); Ivo Sedlacek, Hovorcovice (CZ); Paul Schliwa-Bertling, Ljungsbro (SE); Peter Hedman, Helsingborg (SE)

(21) Appl. No.: 16/764,561

(22) PCT Filed: Nov. 20, 2017
(86) PCT No.: PCT/EP2017/079818

§ 371 Date: May 15, 2020

(51) Int. Cl. H04W 28/02; H04W 28/12; H04W 12/00; H04L 29/06

(52) U.S. Cl. CPC H04W 28/0268; H04L 63/164; H04W 12/0013; H04W 28/12

(57) ABSTRACT

A method performed by a wireless device for enabling reflective Quality-of-Service, QoS, to a bi-directional communications flow in a wireless communications network is provided. The wireless device receives a downlink, DL, data packet of the bi-directional communications flow indicating that reflective QoS is to be applied. The wireless device then determines, based on the type of the bi-directional communications flow, that a first reflective QoS rule for filtering Uplink, UL, data packets of the bi-directional communications flow cannot be derived based on control information comprised in the DL data packet. The wireless device further obtains, based on the control information comprised in the DL data packet and the type of the bi-directional communications flow, a second reflective QoS rule for filtering UL data packets such that the control information comprised in an UL data packet is at least partly different from the control information comprised in the DL data packet.

### TECHNICAL FIELD

Embodiments herein relate to reflective Quality-of-Service, QoS, in a wireless communications network. In particular, embodiments herein relate to wireless device and method therein for enabling reflective QoS to a bi-directional communications flow in a wireless communications network.

### BACKGROUND

A wireless communications network conventionally comprises radio base stations, also referred to as network nodes, providing radio coverage over at least one respective geographical area forming a so-called cell. Wireless devices, also referred to herein as User Equipments, UEs, mobile stations, and/or wireless terminals, are served in the cells by the respective radio base station. The wireless devices transmit data over an air or radio interface to the radio base stations in uplink, UL, transmissions and the radio base stations transmit data over an air or radio interface to the wireless devices in downlink, DL, transmissions. In today's wireless communications networks a number of different technologies are used, such as, for example, 5G/New Radio (NR), Long Term Evolution (LTE), LTE-Advanced, Wideband Code Division Multiple Access (WCDMA), Global System for Mobile communications/Enhanced Data rate for GSM Evolution (GSM/EDGE), Worldwide Interoperability for Microwave Access (WiMax), or Ultra Mobile Broadband (UMB), just to mention a few possible technologies for wireless communication.

One of the technologies for a wireless communications network that is currently being worked on is the 5G or New Radio (NR) system architecture. Section 5.7.5 from the standard document 3GPP TS 23.501 “System architecture for the 5G system” Release 15, version 1.5.0 relates to the concept of implementing so-called reflective Quality-of-Service, QoS, for bi-directional communications flows. This section is also what is referred to hereinafter when referring to the standard. According to this standard, reflective QoS is achieved by creating a derived QoS rule in the wireless device based on the received downlink traffic. The derived QoS rule is then used to filter UL data packets such that the UL data packets for traffic that is subject to the reflective QoS is provided with the same QoS marking as the reflected DL data packet.

The derived QoS rule in the wireless device contains, according to the standard, the following parameters: a Packet Filter Set; a Quality Flow Indicator, QFI; and a Precedence value.

The Packet Filter Set for UL data packets in the derived QoS rule is derived by the wireless device based on the received DL data packet, for example, the source IP address and port number of the DL data packet is used as the destination IP address and port number of the UL data packet, and vice versa. For a IP PDU session type, the Packet Filter Set supports UL packet filtering based on at least any combination of: a source and/or destination IP address or IPv6 prefix; a source and/or destination port number; a Protocol ID of the protocol above IP/Next header type; a Type of Service (TOS) (IPv4)/Traffic class (IPv6) and Mask; a Flow Label (IPv6), and a Security Parameter Index, SPI. The QFI for the UL data packet filtered by the derived QoS rule is set to the same QFI as received in the DL packet. When reflective QoS is activated, the precedence value for all derived QoS rules is set to a standardised value.

Furthermore, according to the standard, upon reception of a DL packet that is subject to reflective QoS and if a derived QoS rule in the wireless device with a Packet Filter Set corresponding to the DL data packet does not already exist, the wireless device creates a new UE derived QoS rule with a Packet Filter Set that corresponds to the DL data packet. Here, it is important to note that, for reflective QoS, the wireless device may receive a DL data packet and based on that DL data packet create or derive a QoS rule in the wireless device that is based on the values of the actual fields of the control information in the DL data packet, such as, for example, in the IPv4/v6, IPsec ESP, AH and TCP/UDP headers of the DL data packet. The information, i.e. value or fields, in these headers will be mirrored by the derived QoS rule for UL data packets. For example, in case the wireless device receives a DL data packet with source IP address=“1.1.1.1” and destination address=“2.2.2.2”, the wireless device will create or derive, unless there already is a corresponding derived QoS rule, a QoS rule for UL data packet in the wireless device based on the source address=“2.2.2.2” and destination address=“1.1.1.1” for the derived filter, i.e. the source and destination addresses of the DL data packet will be mirrored, or filtered, by the derived QoS rule such that the source address becomes the destination address for the UL data packet and the destination address becomes the source address for the UL data packet. UL data packets matching the derived filter of the QoS rule will get same QoS as the received DL data packet.

The benefits of implementing reflective QoS for bi-directional communications flows in a wireless communications network is that it reduces the amount of signalling to setup QoS flows, and provides an efficient way of changing what traffic flows that should receive a certain QoS. Hence, it would be advantageous to be able to implement reflective QoS for as many bi-directional communications flows as possible in a wireless communications network.

### SUMMARY

It is an object of embodiments herein to enable reflective QoS for bi-directional communications flows in a wireless communications network.

According to a first aspect of embodiments herein, the object is achieved by a method performed by a wireless device for enabling reflective Quality-of-Service, QoS, to a bi-directional communications flow in a wireless communications network. The wireless device receives a downlink, DL, data packet of the bi-directional communications flow indicating that reflective QoS is to be applied. The wireless device also determines, based on the type of the bi-directional communications flow, that a first reflective QoS rule for filtering Uplink, UL, data packets of the bi-directional communications flow cannot be derived based on control information comprised in the DL data packet. Furthermore, the wireless device derives, based on the control information comprised in the DL data packet and the type of the bi-directional communications flow, a second reflective QoS rule for filtering UL data packets such that the control information comprised in an UL data packet is at least partly different from the control information comprised in the DL data packet.

According to a second aspect of embodiments herein, the object is achieved by a wireless device for enabling reflective Quality-of-Service, QoS, to a bi-directional communications flow in a wireless communications network. The wireless device is configured to receive a downlink, DL, data packet of the bi-directional communications flow indicating that reflective QoS is to be applied. The wireless device is also configured to determine, based on the type of the bi-directional communications flow, that a first reflective QoS rule for filtering Uplink, UL, data packets of the bi-directional communications flow cannot be derived based on control information comprised in the DL data packet. Further, the wireless device is configured to derive, based on the control information comprised in the DL data packet and the type of the bi-directional communications flow, a second reflective QoS rule for filtering UL data packets such that the control information comprised in an UL data packet is at least partly different from the control information comprised in the DL data packet.

According to a third aspect of the embodiments herein, a computer program is also provided configured to perform the method described above. Further, according to a fourth aspect of the embodiments herein, carriers are also provided configured to carry the computer program configured for performing the method described above.

By being able to, upon receiving a DL data packet indicating that reflective QoS is to be applied, detect that the bi-directional communications flow is of a type for which a conventional reflective QoS rule cannot be derived, and further being able to derive another reflective QoS rule based on this type of bi-directional communications flow and the control information in the DL data packet, the wireless device enables reflective QoS to be implemented for an increased number of bi-directional communications flows in a wireless communications network. Hence, reflective QoS for bi-directional communications flows in a wireless communications network is enabled.

### BRIEF DESCRIPTION OF THE DRAWINGS

Features and advantages of the embodiments will become readily apparent to those skilled in the art by the following detailed description of exemplary embodiments thereof with reference to the accompanying drawings, wherein:

FIG. 1 is a schematic block diagram illustrating embodiments of a wireless device in a wireless communications network,

FIG. 2 is a flowchart depicting embodiments of a method in a wireless device,

FIG. 3 is another flowchart depicting embodiments of a method in a wireless device,

FIG. 4 is a further flowchart depicting embodiments of a method in a wireless device, and

FIG. 5 is a block diagram depicting embodiments of a wireless device.

### DETAILED DESCRIPTION

The figures are schematic and simplified for clarity, and they merely show details which are essential to the understanding of the embodiments presented herein, while other details have been left out. Throughout, the same reference numerals are used for identical or corresponding parts or steps.

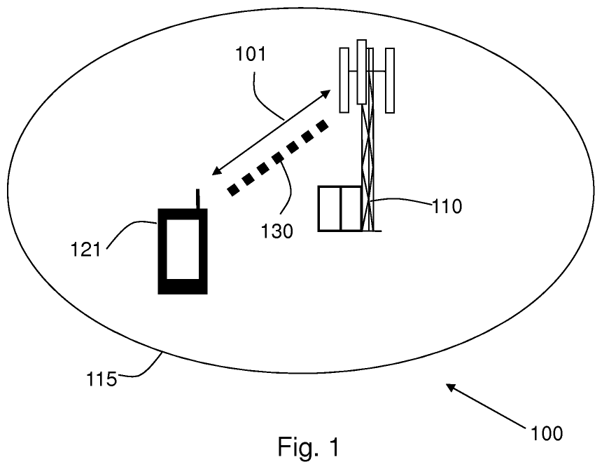

FIG. 1 depicts a wireless communications network 100 in which embodiments herein may operate. In some embodiments, the wireless communications network 100 may be a radio communications network, such as, 5G/New Radio (NR) network. Although, the wireless communications network 100 is exemplified herein as an 5G/NR network, the wireless communications network 100 may also employ technology of any one of Long Term Evolution (LTE), LTE-Advanced, Wideband Code Division Multiple Access (WCDMA), Global System for Mobile communications/Enhanced Data rate for GSM Evolution (GSM/EDGE), Worldwide Interoperability for Microwave Access (WiMax), Ultra Mobile Broadband (UMB) or GSM, or any other similar network or system. The wireless communications network 100 may also be an Ultra Dense Network, UDN, which e.g. may transmit on millimetre-waves (mmW).

The wireless communications network 100 comprises a network node 110. The network node 110 serves at least one cell 115. The network node 110 may correspond to any type of network node or radio network node capable of communicating with a wireless device and/or with another network node, such as, e.g. be a base station, a radio base station, gNB, eNB, eNodeB, a Home Node B, a Home eNode B, femto Base Station (BS), pico BS, etc., in the wireless communications network 100. Further examples of the network node 110 may also be e.g. repeater, base station (BS), multi-standard radio (MSR) radio node such as MSR BS, eNodeB, network controller, radio network controller (RNC), base station controller (BSC), relay, donor node controlling relay, base transceiver station (BTS), access point (AP), transmission points, transmission nodes, a Remote Radio Unit (RRU), a Remote Radio Head (RRH), nodes in distributed antenna system (DAS), core network node (e.g. MSC, MME, etc.), O&M, OSS, SON, positioning node (e.g. E-SMLC), MDT, etc.

In FIG. 1, a wireless device 121 is located within the cell 115. The wireless device 121 is configured to communicate within the wireless communications network 100 via the network node 110 over a radio link 101 served by the network node 110. Utilizing the radio link 101, a bi-directional communications flow 130 may be set up between the wireless device 121 and any entity capable of communication via the wireless communications network 100. The wireless device 121 may refer to any type of wireless device or user equipment (UE) communicating with a network node and/or with another wireless device in a cellular, mobile or radio communication network or system. Examples of such wireless devices are mobile phones, cellular phones, Personal Digital Assistants (PDAs), smart phones, tablets, sensors equipped with a UE, Laptop Mounted Equipment (LME) (e.g. USB), Laptop Embedded Equipments (LEEs), Machine Type Communication (MTC) devices, or Machine to Machine (M2M) device, Customer Premises Equipment (CPE), target device, device-to-device (D2D) wireless device, wireless device capable of machine to machine (M2M) communication, etc.

Furthermore, although embodiments below are described with reference to FIG. 1, this should not be construed as limiting to the embodiments herein, but merely as an example made for illustrative purposes.

As part of the developing of the embodiments described herein, it has been realized that while reflective QoS may work well for some bi-directional communications flows, it may not work so well for other bi-directional communications flows.

One case is when the bi-directional communications flow is a IPsec protected communication. This because the Security Parmeter Index, SPI, of a DL data packet of the IPsec protected communication will be used by the wireless device to create the Packet Filter Set upon deriving the QoS rule. IPsec consist of two different protocols that define its SPI, Encapsulated Security Payload, ESP, and Authentication Header, AH. For ESP, the SPI is defined in RFC 4303, section 2.1, as: “The SPI is an arbitrary 32-bit value that is used by a receiver to identify the Security Association (SA) to which an incoming packet is bound. The SPI field is mandatory. For a unicast SA, the SPI can be used by itself to specify an SA, or it may be used in conjunction with the IPsec protocol type (in this case ESP). Because the SPI value is generated by the receiver for a unicast SA, whether the value is sufficient to identify an SA by itself or whether it must be used in conjunction with the IPsec protocol value is a local matter.” Similarly, for AH, the SPI is defined in RFC 4302, section 2.4 as: “The SPI is an arbitrary 32-bit value that is used by a receiver to identify the Security Association (SA) to which an incoming packet is bound. For a unicast SA, the SPI can be used by itself to specify an SA, or it may be used in conjunction with the IPsec protocol type (in this case AH). Because for unicast SAs the SPI value is generated by the receiver, whether the value is sufficient to identify an SA by itself or whether it must be used in conjunction with the IPsec protocol value is a local matter.” This means that a wireless device receiving an ESP/AH data packet with a unicast SA in the DL direction will use the SPI to identify the Security Association (SA) that the received ESP/AH data packet belongs to. However, it also means that it is the wireless device that will generate the SPI for the ESP/AH data packet with a unicast SA in the UL direction. This further explained in IKE RFC 7296 as: “ESP and AH SAs always exist in pairs, with one SA in each direction.” This means that a bi-directional communications flow that is a IPsec protected communication must use two SAs, one for each direction. Since it is the wireless device that determine what SPI is used for a SA, it will typically mean that different SPI values will used for each direction. For reflective QoS, this means that the SPI field in the Packet Filter Set will be wrong, since it will copy the SPI value from the DL data packet.

Another case is when the bi-directional communications flow is a IMS voice flow. An IMS voice flow comprise a bi-directional flow of voice IP data packets. However, the IMS voice flow is not required to use the same ports when receiving and transmitting the voice IP data packets in each direction, which means that each end of the IMS voice flow may use different ports for reception and transmission of the voice IP data packets. For reflective QoS, this means that the source and destination ports in the Packet Filter Set will be wrong, since it will mirror the source and destination ports from the DL data packet.

Hence, for these types of bi-directional communications flows, reflective QoS is currently not applicable. This may also be extended to any bi-directional communications flow for which the exact same control information as comprised in the received DL data packet may be used for filtering out the outgoing UL data packets according to the reflective QoS rule.

However, these issues are addressed by the embodiments herein by, upon receiving a DL data packet for which the control information indicates that reflective QoS is to be applied, determining that the bi-directional communications flow is of a type for which a conventional reflective QoS rule cannot be derived, such as, e.g. a IPsec protected communication or a IMS voice flow. Based on the particular type of bi-directional communications flow and the control information in the DL data packet, Thus, another reflective QoS rule may be derived instead. This advantageously enables reflective QoS to be implemented for an increased number of bi-directional communications flows in a wireless communications network.

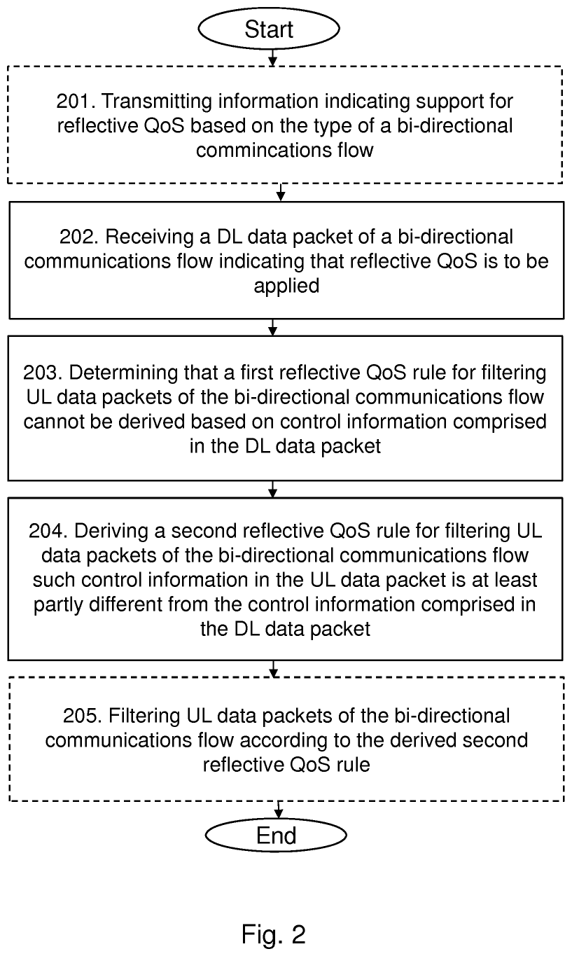

Embodiments of the wireless device 121 and a method therein will be described in more detail below with reference to FIGS. 2-5.

Example of embodiments of a method performed by a wireless device 121 for enabling reflective Quality-of-Service, QoS, to a bi-directional communications flow 130 in the wireless communications network 100 will now be described with reference to the flowchart depicted in FIG. 2. FIG. 2 is an illustrated example of actions or operations which may be taken by a wireless device 121 in the wireless communication network 100. The method may comprise the following actions.

Action 201

Optionally, the wireless device 121 may transmit information, to a network node 110 serving the wireless device 121 in the wireless communications network 100, indicating that the wireless device 121 supports reflective QoS based on the type of the bi-directional communications flow 130 in the wireless communications network 100. This means that the wireless device 121 may notify the network node 110 about its capability to apply reflective QoS service to an extended number of bi-directional communications flows. This support or capability may, for example, be indicated by the wireless device 121 during the registration to the network, or during establishing packet connectivity, such as, e.g. during a PDU Session Establishment as defined in the standard 3GPP TS 23.502. This advantageously allows the network node 110 to be informed about the fact that it does not need to apply any other means to enable QoS differentiation.

Additionally, the network node 110 may transmit information indicating that the wireless communications network 100 support reflective QoS for bi-directional communications flows. This information may be sent to the wireless device 121, for example, from a PCF node via SMF- and AMF-nodes in the wireless communications network 100. This may, for example, be performed during a PDU Session Establishment.

Action 202

The wireless device 121 receives a downlink, DL, data packet of the bi-directional communications flow 130 indicating that reflective QoS is to be applied. Here, the DL data packet may be an Internet Protocol, IP, packet comprising control information and data payload. The DL data packet may indicate that reflective QoS is to be applied to the bi-directional communications flow 130 by comprising control information indicating that reflective QoS is to be applied to the bi-directional communications flow 130. This control information may, for example, correspond to a QoS Flow indicator, QFI, and/or a Reference Quality Indicator, RQI.

It is preferred that the control information indicates at least one first reflective parameter of a certain category, which parameter is intended to be reflected (i.e. copied, i.e. mirrored) into Uplink, UL, data packets of the bi-directional communications flow (130). In some embodiments, the control information or said first reflective parameter in the DL data packet may further indicate any one of: a source/destination IP address; an IPv6 prefix; a source/destination port number; a transport protocol identity; and a Security Parameter Index, SPI. The control information may, for example, be comprised in IP/UDP/TCP/RTP header fields in the DL data packet.

Action 203

After the reception in Action 202, the wireless device 121 determines, based on the type of the bi-directional communications flow 130, that a reflective QoS rule, e.g. such as a first reflective QoS rule, for filtering uplink, UL, data packets of the bi-directional communications flow 130 cannot be derived based on control information comprised in the DL data packet. Preferably, this is accomplished in that the wireless device 121 determines, based on the type of the bi-directional communications flow 130, that said first reflective parameter cannot be reflected (i.e. copied, i.e. mirrored) into UL data packets of the bi-directional communications flow (130). In other words, a first reflective QoS rule cannot be used or applied that reflects said at least one first reflective parameter into UL data packets of the bi-directional communications flow (130). This means that the wireless device 121 is able to determine that the bi-directional communications flow is of a type for which a conventional reflective QoS rule cannot be derived.

According to some embodiments, a type of bi-directional communications flow 130 that the wireless device 121 may determine is of a type for which a conventional reflective QoS rule cannot be derived is an IPsec protected communication or IPsec communication. Optionally, in some embodiments, a type of bi-directional communications flow 130 that the wireless device 121 may determine is of a type for which a conventional reflective QoS rule cannot be derived is an IMS voice flow.

Action 204

After determining that a first reflective QoS rule cannot be derived in Action 203, the wireless device 121 derives, based on the control information comprised in the DL data packet and the type of the bi-directional communications flow 130, a reflective QoS rule, e.g. a second reflective QoS rule, for filtering UL data packets such that the control information comprised in an UL data packet is at least partly different from the control information comprised in the DL data packet. Preferably, this is accomplished in that the wireless device 121 provides the UL data packet with control information that indicates a second reflective parameter of the same category as said at first reflective parameter, but that is at least partly different from the first reflective parameter. For example, if the first reflective parameter corresponds to a first source/destination IP address or a first IPv6 prefix or a first source/destination port number or a first transport protocol identity or a first Security Parameter Index, SPI, then the second reflective parameter may be a second source/destination IP address or a second IPv6 prefix or a second source/destination port number or a second transport protocol identity or a second SPI respectively, but that is at least partly different from the first reflective parameter. This means the wireless device 121 may use the information about the type of the bi-directional communications flow in order to identify which control information is that not able to be mirrored by a first reflective QoS rule and thus needs to be exchanged. Also, in order to retrieve the new control information, the wireless device 121 may use the control information comprised in the DL data packet.

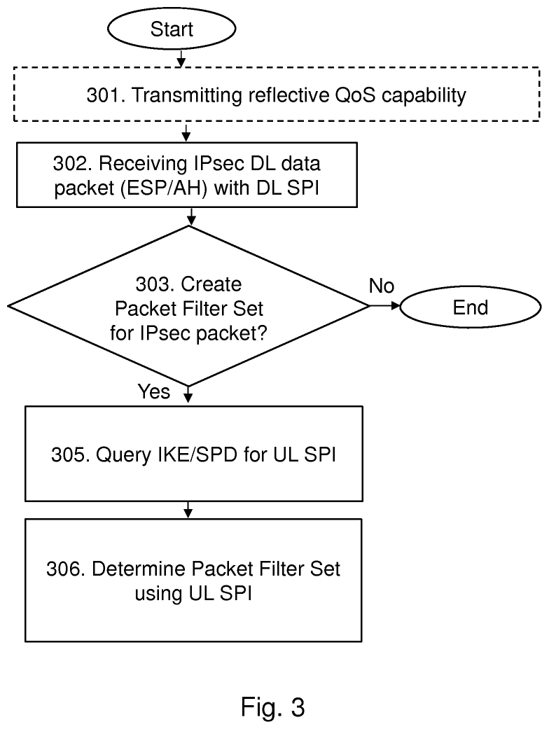

In some embodiments, in case the type of bi-directional communications flow 130 is an IPsec protected communication, the control information to be comprised in the UL data packet that is at least partly different from the information comprised in the DL data packet is a Security Parameter Index, SPI. This means that the wireless device 121 is able to create a new UE derived QoS rule, i.e. the second reflective QoS rule, with a packet filter set indicating the correct SPI for the IPsec SA used in the uplink direction based on a received DL data packet comprising an SPI for a IPsec SA in the downlink direction. In other words, the SPI value of the corresponding egress SA shall be used instead of the SPI value of the ingress SA; that is, when the wireless device 121 shall create the new UE derived QoS rule for an IPsec data packet, such as, an ESP/AH data packet, the wireless device 121 use the SPI value of the corresponding IPsec SA for the outbound UL direction, i.e. uplink SPI value, according to the second UE derived QoS rule instead of directly copying the SPI value of the received DL data packet, i.e. downlink SPI value. This is also described below in reference to the flowchart depicted in FIG. 3.

One part of the problem is for the wireless device 121 to determine the correct uplink-SPI value, i.e. SPI value to be used in uplink IPSec packets, corresponding to downlink-SPI value, i.e. SPI value a received downlink IPsec packet. Hence, the wireless device 121 may query a local database in the wireless device 121 based on the SPI received in the DL data packet in order to obtain another SPI to be comprised in the control information of the UL data packet. According to some embodiments, the local database may be an Internet Key Exchange, IKE, database maintained in the wireless device 121. This may be the case when the wireless device 121 has used IKE in order to setup the Security Associations, SAs, of the IPsec. In this case, the wireless device 121 may query the local IKE database to get an uplink SPI value corresponding to the downlink SPI value, i.e. SPI of the received downlink IPSec packet. Upon receiving the uplink SPI value, the wireless device 121 may directly generate a derived the new QoS rule based the uplink SPI value, i.e. derive the second reflective QoS rule.

Optionally, in some embodiments, the local database may be a Security Policy Database, SPD, maintained in the wireless device 121. This may be the case when the wireless device 121 uses the transport mode of the IPsec protected communication. In this case, a SPD is maintained in the wireless device 12 which will comprise information on which IP packets should be sent on an outbound SA and which IP packets are allowed on an inbound SA. The SPD may be an SPD according to RFC4301. According to some embodiments, the wireless device 121 may decrypt the IPsec protected DL data packet of the IPsec protected communication in order to obtain the SPI comprised in the DL data packet. The decryption may be performed in order to first determine some control information of the encrypted downlink IPsec data packet, such as, the local IP address, local port, protocol, remote IP address, remote port of the encrypted downlink IPsec data packet, and then by querying the SPD, determine the SPI value to associated with uplink IP data packets of the protocol sent from local IP address and local port towards the remote IP address and remote port and set this SPI value as the uplink SPI value in the Packet Filter Set of the second reflective QoS rule.

According to another alternative, an upper layer application may also provide a mapping between downlink SPI value used by the application and an uplink SPI value to be used for UL data packets. In this case, the wireless device 121 may query an application in the wireless device 121 based on the SPI received in the DL data packet in order to obtain another SPI to be comprised in the control information of the UL data packet.

In some embodiments, the wireless device 121 may query an application in the wireless device 121, based on the control information comprised in the DL data packet and the type of the bi-directional communications flow 130, in order to obtain the control information to be comprised in the control information of the UL data packet that is at least partly different from the information comprised in the DL data packet. This means that the wireless device 121 may derive a second reflective QoS rule for any bi-directional application flows that don't use the exact same control information, for example, control information in IP/UDP/TCP/RTP header fields, such as, e.g. source IP address, destination IP address, source and destination ports, flow label or other control information, by just mirroring the control information in these fields of the received DL data packet. In other words, this means the wireless device 121 may request information about the desired control information from a higher layer in the TCP/IP stack, e.g. the application layer.

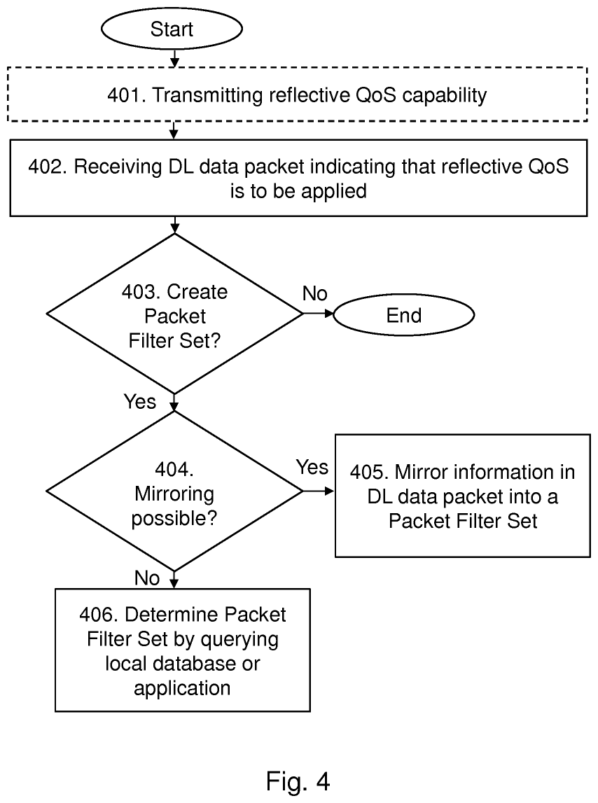

For example, the application may be an application running on the IMS layer or another applications layer. In some embodiments, in case the type of bi-directional communications flow 130 is an IMS voice communication, the control information to be comprised in the UL data packet that is at least partly different from the information comprised in the DL data packet may be source and/or destination port numbers. As described above, an IMS voice flow is not required to use the same ports when receiving and transmitting the voice IP data packets in each direction, which means that each end of the IMS voice flow may use different ports for reception and transmission of the voice IP data packets. Which ports or port numbers that are used is communicated between the end points of the bi-directional communications flow on application level utilizing, for example, an SPD database. To be able to apply reflective QoS for these bi-directional communications flows, the wireless device 121 may query the application, e.g. the SPD, in order to obtain the correct port or port numbers to apply in the Packet Filter Set of the derived second reflective QoS rule for UL data packets. This is also described below in reference to the flowchart depicted in FIG. 4.

Action 205

Optionally, after the derivation of the second QoS rule in Action 204, the wireless device 121 may filter UL data packets of the bi-directional communications flow 130 according to the derived second reflective QoS rule. This means that the wireless device 121 may apply the derived second reflective QoS rule to UL data packets of the bi-directional communications flow such that the control information comprised in an UL data packet is at least partly different from the control information comprised in the DL data packet.

FIG. 3 shows a flowchart illustrating an example of some embodiments of a method in a wireless device 121. In this example, the bi-directional communications flow is a IPsec protected communication.

Action 301.

The wireless device 121 may transmit information indicating its support or capability to perform reflective QoS based on the type of the bi-directional communications flow. Alternatively, the wireless device 121 may transmit information indicating its support or capability to perform reflective QoS for IPsec protected communications.

Action 302.

The wireless device 121 may then receive a DL data packet (ESP/AH) with a DL SPI of a IPsec protected communication.

Action 303.

After receiving the DL data packet in Action 302, the wireless device 121 may determine whether or not to create new reflective QoS rule, or rather a new Packet Filter Set of a reflective QoS rule for corresponding UL data packets of the IPsec communication. If there already exist a reflective QoS rule corresponding to the DL data packet, then there is no reason for the wireless device 121 to create a new reflective QoS rule. However, if no reflective QoS rule corresponding to the DL data packet exist, the wireless device 121 may proceed to querying a local database in the wireless device 121 according to Action 304.

Action 304.

The wireless device 121 may then use the fact that the bi-directional communication is an IPsec protected communication and control information comprised in the DL data packet, such as, e.g. the DL SPI, in order to obtain a UL SPI for the UL data packets of the IPsec protected communication. This may be performed towards a IKE/SPD database depending on whether IKE was used to set up the IPsec communications or if the IPsec protected communication is in transport mode. In other word, the wireless device 121 query the local database to find out if there is a UL SPI defined in the database for the IPsec SA for the uplink direction.

Action 305.

After retrieving the UL SPI, the wireless device 121 may derive a Packet Filter Set of a new reflective QoS rule for the IPsec protected communication based on the UL SPI.

FIG. 4 shows a flowchart illustrating another example of some embodiments of a method in a wireless device 121. In this example, the bi-directional communications flow may be any bi-directional application flows that don't use the exact same control information, for example, control information in IP/UDP/TCP/RTP header fields, such as, e.g. source IP address, destination IP address, source and destination ports, flow label or other control information, by just mirroring the control information in these fields of the received DL data packet. One example of such a bi-directional application flow, and which referred to in this example, is an IMS voice flow.

Action 401.

The wireless device 121 may transmit information indicating its support or capability to perform reflective QoS based on the type of the bi-directional communications flow. Alternatively, the wireless device 121 may transmit information indicating its support or capability to perform reflective QoS for a specific bi-directional communication flow, e.g. a IMS voice flow.

Action 402.

The wireless device 121 may then receive a DL data packet of the bi-directional communications flow, e.g. a IMS voice flow. The DL data packet may indicate that reflective QoS is to be applied, for example, by comprising a RQI and/or a CQI indicator or information.

Action 403.

After receiving the DL data packet in Action 402, the wireless device 121 may determine whether or not to create new reflective QoS rule, or rather a new Packet Filter Set of a reflective QoS rule for corresponding UL data packets of the bi-directional communications flow. If there already exist a Packet Filter Set of a reflective QoS rule corresponding to the DL data packet, then there is no reason for the wireless device 121 to create a new reflective QoS rule. However, if no Packet Filter Set of a reflective QoS rule corresponding to the DL data packet exist, the wireless device 121 may proceed to determine whether the control information in the DL data packet can be mirrored in a Packet Filter Set according to a new reflective QoS rule for UL data packets of the bi-directional communications flow according to Action 404.

Action 404.

The wireless device 121 may determine whether the control information in the DL data packet can be mirrored in a Packet Filter Set according to a new reflective QoS rule for UL data packets of the bi-directional communications flow by determining the type of the bi-directional communications flow, e.g. that the bi-directional communications flow is a IMS voice flow.

Action 405.

If the type of the bi-directional communication is a type for which the conventional reflective QoS rule applies, the wireless device 121 may mirror the control information in DL data packet into a Packet Filter Set of a reflective QoS rule for the bi-directional communications flow. This is, however, not the case for an IMS voice flow since an IMS voice flow is not required to use the same ports when receiving and transmitting the voice IP data packets in each direction, which means that each end of the IMS voice flow may use different ports for reception and transmission of the voice IP data packets. Hence, mirroring of the control information in the DL data packet according to the conventional reflective QoS rule does not work in this case.

Action 406.

If the type of the bi-directional communication is a type for which the conventional reflective QoS rule do not apply, such as, in the case of the bi-directional communication being an IMS voice flow, the wireless device 121 may query a local database or application to determine the new control information to be comprised in the Packet Filter Set of the reflective QoS rule for filtering the UL data packets of the bi-directional communications flow. In the case of the bi-directional communication being an IMS voice flow, this means that the wireless device 121 may query an SPD in order to obtain the correct port or port numbers to apply in the Packet Filter Set of the new reflective QoS rule for UL data packets of the IMS voice flow.

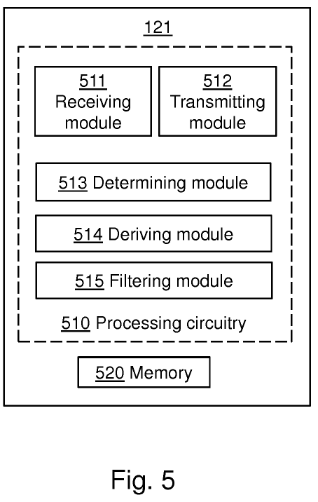

To perform the method actions in the wireless device 121 for enabling reflective QoS to a bi-directional communications flow 130 in a wireless communications network 100, the wireless device 121 may comprise the following arrangement depicted in FIG. 5. FIG. 5 shows a schematic block diagram of embodiments of a wireless device 121. The embodiments of the wireless device 121 described herein may be considered as independent embodiments or may be considered in any combination with each other to describe non-limiting examples of the example embodiments described herein.

The wireless device 121 may comprise processing circuitry 510, a memory 520 and at least one antenna (not shown). The processing circuitry 510 may also comprise a receiving module 511 and a transmitting module 512. The receiving module 511 and the transmitting module 512 may comprise Radio Frequency, RF, circuitry and baseband processing circuitry capable of receiving and transmitting a radio signal in the wireless communications network 100. The receiving module 511 and the transmitting module 512 may also form part of a single transceiver. It should also be noted that some or all of the functionality described in the embodiments above as being performed by the wireless device 121 may be provided by the processing circuitry 510 executing instructions stored on a computer-readable medium, such as, e.g. the memory 520 shown in FIG. 5. Alternative embodiments of the wireless device 121 may comprise additional components, such as, for example, a determining module 513, a deriving module 514 and a filtering module 515, each responsible for providing its respective functionality necessary to support the embodiments described herein.

The wireless device 121 or processing circuitry 510 is configured to, or may comprise a receiving module 511 configured to, receive a DL, data packet of the bi-directional communications flow 130 indicating that reflective QoS is to be applied. Also, the wireless device 121 or processing circuitry 510 is configured to, or may comprise a determining module 513 configured to, determine, based on the type of the bi-directional communications flow 130, that a first reflective QoS rule for filtering UL data packets of the bi-directional communications flow 130 cannot be derived based on control information comprised in the DL data packet. Further, the wireless device 121 or processing circuitry 1510 is configured to, or may comprise a deriving module 514 configured to, derive, based on the control information comprised in the DL data packet and the type of the bi-directional communications flow 130, a second reflective QoS rule for filtering UL data packets such that the control information comprised in an UL data packet is at least partly different from the control information comprised in the DL data packet.

In some embodiments, the wireless device 121 or processing circuitry 510 may be configured to, or may comprise a filtering module 515 configured to, filter UL data packets of the bi-directional communications flow 130 according to the derived second reflective QoS rule. In some embodiments, the control information in the DL data packet may indicate any one of: a source/destination IP address; an IPv6 prefix; a source/destination port number; a transport protocol identity; and a Security Parameter Index, SPI.

According to some embodiments, a type of bi-directional communications flow 130 may be an IPsec protected communication. In this case, the control information to be comprised in the UL data packet that is at least partly different from the control information comprised in the DL data packet is a Security Parameter Index, SPI. In some embodiments, the wireless device 121 or processing circuitry 510 may be configured to, or may comprise the deriving module 514 configured to, query a local database in the wireless device 121 based on the SPI received in the DL data packet in order to obtain another SPI to be comprised in the UL data packet. According to some embodiments, the local database may be an Internet Key Exchange, IKE, database maintained in the wireless device 121, or a Security Policy Database, SPD, maintained in the wireless device 121. In some embodiments, the wireless device 121 or processing circuitry 510 may be configured to, or may comprise the deriving module 514 configured to, decrypt the IPsec protected DL data packet of the IPsec protected communication in order to obtain the SPI comprised in the DL data packet. Optionally, in some embodiments, the wireless device 121 or processing circuitry 510 may be configured to, or may comprise the deriving module 514 configured to, query an application in the wireless device 121 based on the SPI received in the DL data packet in order to obtain another SPI to be comprised in the UL data packet.

In some embodiments, the wireless device 121 or processing circuitry 510 may be configured to, or may comprise the deriving 514 configured to, query an application in the wireless device 121, based on the control information comprised in the DL data packet and the type of the bi-directional communications flow 130, in order to obtain the control information to be comprised in the UL data packet that is at least partly different from the control information comprised in the DL data packet. Here, according to some embodiments, a type of bi-directional communications flow 130 may be an IMS voice communication. In this case, the control information to be comprised in the UL data packet that is at least partly different from the control information comprised in the DL data packet are the source and/or destination port numbers.

In some embodiments, the wireless device 121 or processing circuitry 510 may be configured to, or may comprise the transmitting module 512 configured to, transmit information, to a network node 110 serving the wireless device 121 in the wireless communications network 100, indicating that the wireless device 121 supports reflective QoS based on the type of the bi-directional communications flow 130 in the wireless communications network 100.

Furthermore, the embodiments for enabling reflective QoS to a bi-directional communications flow 130 in a wireless communications network 100 described above may be implemented through one or more processors, such as the processing circuitry 510 in the wireless device 121 depicted in FIG. 5, together with computer program code for performing the functions and actions of the embodiments herein. The program code mentioned above may also be provided as a computer program product, for instance in the form of a data carrier carrying computer program code or code means for performing the embodiments herein when being loaded into the processing circuitry 510 in the wireless device 121. The computer program code may e.g. be provided as pure program code in the wireless device 121 or on a server and downloaded to the wireless device 121. Thus, it should be noted that the modules of the wireless device 121 may in some embodiments be implemented as computer programs stored in memory, e.g. in the memory modules 520 in FIG. 5, for execution by processors or processing modules, e.g. the processing circuitry 510 of FIG. 15.

Those skilled in the art will also appreciate that the processing circuitry 510 and the memory 520 described above may refer to a combination of analog and digital circuits, and/or one or more processors configured with software and/or firmware, e.g. stored in a memory, that when executed by the one or more processors such as the processing circuitry 520 perform as described above. One or more of these processors, as well as the other digital hardware, may be comprised in a single application-specific integrated circuit (ASIC), or several processors and various digital hardware may be distributed among several separate components, whether individually packaged or assembled into a system-on-a-chip (SoC).

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that the example embodiments presented herein may be practiced in any combination with each other.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same item of hardware.

It should also be noted that the various example embodiments described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

The embodiments herein are not limited to the above described preferred embodiments. Various alternatives, modifications and equivalents may be used. Therefore, the above embodiments should not be construed as limiting.

### Abbreviations

### QoS Quality of Service

### QFI Quality Flow Indicator

### SPI Security Parameter Index

### ESP Encapsulated Security Payload

### AH Authentication Header

### SA Security Association

### IMS IP Multimedia Subsystem

### DL Downlink

### UL Uplink

### IKE Internet Key Exchange

### SPD Security Policy Database

1-27. (canceled)

28. A method performed by a wireless device for enabling reflective Quality-of-Service, QoS, to a bi-directional communications flow in a wireless communications network, the method comprising:
receiving a downlink, DL, data packet of the bi-directional communications flow indicating that reflective QoS is to be applied and comprising a DL Security Parameter Index, SPI, for an IPsec Security Association, SA, used in the DL direction, where the type of bi-directional communications flow is an IPsec protected communication;
determining to create a new Packet Filter Set of a reflective QoS rule for corresponding uplink, UL, data packets of the IPsec communication; and
obtaining by querying a local database in the wireless device, a UL SPI for a corresponding IPsec SA used in the UL direction for the UL data packets of the IPsec protected communication using the DL SPI and the fact that the bi-directional communication is an IPsec protected communication, where the UL SPI shall be used instead of the DL SPI for the UL data packets.

29. A wireless device for enabling reflective Quality-of-Service, QoS, to a bi-directional communications flow in a wireless communications network, the wireless device being configured to:
receive a downlink, DL, data packet of the bi-directional communications flow indicating that reflective QoS is to be applied and comprising a DL Security Parameter Index, SPI, for an IPsec Security Association, SA, used in the DL direction, where the type of bi-directional communications flow is an IPsec protected communication;
determine to create a new Packet Filter Set of a reflective QoS rule for corresponding uplink, UL, data packets of the IPsec communication; and
obtain by querying a local database in the wireless device, a UL SPI for a corresponding IPsec SA used in the UL direction for the UL data packets of the IPsec protected communication using the DL SPI and the fact that the bi-directional communication is an IPsec protected communication, where the UL SPI shall be used instead of the DL SPI for the UL data packets.
